(19) United States
(12) Patent Application Publication
(10) Pub. No.: US 2020/0180509 A1
(43) Pub. Date: Jun. 11, 2020

(54) Vehicular Camera System for Improving a Driver's Visibility

(71) Applicant: Miguel Angel Rodriguez Ortiz, Denver, CO (US)

(72) Inventor: Miguel Angel Rodriguez Ortiz, Denver, CO (US)

(21) Appl. No.: 16/316,334

(22) PCT Filed: Jul. 20, 2017
(86) PCT No.: PCT/IB2017/054406

§ 371 Date: Jan. 8, 2019

Related U.S. Application Data
(60) Provisional application No. 62/360,095, filed on Jul. 8, 2016.

(51) Int. Cl. B60R 1/00; B60R 11/02; H04N 7/18; H04N 5/247

(52) U.S. Cl. CPC B60R 1/00; B60R 11/0235; B60R 2011/0005; H04N 5/247; H04N 7/181

(57) ABSTRACT

A vehicular camera system is used to improve a driver's visibility around the entire perimeter of their vehicle. The vehicular camera system includes a vehicle, a plurality of cameras, and at least one display panel. The plurality of cameras is external mounted around the vehicle and is preferably positioned at the front, the rear, the left side, and the right side of the vehicle. The plurality of cameras is used to capture real-time footage of the area surround the vehicle and transmits this real-time footage to the display panel. The display panel is peripherally mounted to the steering wheel so that the driver is able to easily view the real-time footage that is visually outputted by the display screen.

The current application is a 371 of international Patent Cooperation Treaty (PCT) application PCT/IB2016/054406 filed on Jul. 20, 2017. The PCT application PCT/IB2016/054406 claims a restored priority to the U.S. Provisional Patent application Ser. No. 62/360,095 filed on Jul. 8, 2016.

### FIELD OF THE INVENTION

The present invention generally relates to a vehicle camera system. More specifically, the present invention relates to a vehicle camera system that displays the complete surroundings of the vehicle to the driver while operating the vehicle.

### BACKGROUND OF THE INVENTION

Car accidents are the result of a variety of factors. Such factors include, high speeds, treacherous weather conditions, distractions within the vehicle, distractions outside the vehicle, and malfunctions of the vehicle itself. However, one common factor that may easily affect a driver in comparison to other factors is a lack of full visibility around the vehicle. Not having full visibility of the surroundings in front of the vehicle may result in the driver running over an item or road block much smaller than the hood of the car. Not having a full visibility of the surroundings behind the vehicle may result in the driver running over a person. Not having full visibility of the surroundings along either side of the vehicle may result in the driver crashing into another vehicle as he or she makes a turn.

The present invention allows a driver to view the surroundings of a vehicle from all angles. The present invention comprises a plurality of cameras, a plurality of display screens, a mounting system, and a plurality of wireless communication devices. The plurality of cameras comprises a set of front cameras, a set of back cameras, and a couple of side cameras. Each of the plurality of cameras are integrated into the vehicle in the corresponding sides of the vehicle. Each of the plurality of cameras are wirelessly connected to the plurality of display screens via the plurality of wireless communication devices. Each of the plurality of display screens are mounted within the car via the mounting system. The plurality of display screens is preferably mounted the dashboard surrounding the driving wheel. The driver may now drive without having to turn his or her head to get a better view of the surroundings of the vehicle. The plurality of display screens presents the user with a view of every angle of the surrounding environment of the vehicle.

### BRIEF DESCRIPTION OF THE DRAWINGS

FIG. 1 is an overall schematic view of the present invention.

FIG. 2 is a schematic view of the present invention, wherein the at least one front camera and the at least one rear camera are a single camera.

FIG. 3 is a schematic view of the present invention, wherein the at least one front camera and the at least one rear camera are a plurality of cameras.

FIG. 4 is a schematic view of the present invention, wherein the at least one left camera and the at least one right camera are positioned adjacent to the forward windshield.

FIG. 5 is a schematic view of the present invention, wherein the at least one left camera and the at least one right camera are positioned in between the front end and the forward windshield.

FIG. 6 is an internal view of the vehicle illustrating the display panels about the steering wheel.

FIG. 7 is a schematic view of the data-transfer routes between the cameras, the computing unit, and the display panels.

### DETAILED DESCRIPTION OF THE INVENTION

All illustrations of the drawings are for the purpose of describing selected versions of the present invention and are not intended to limit the scope of the present invention.

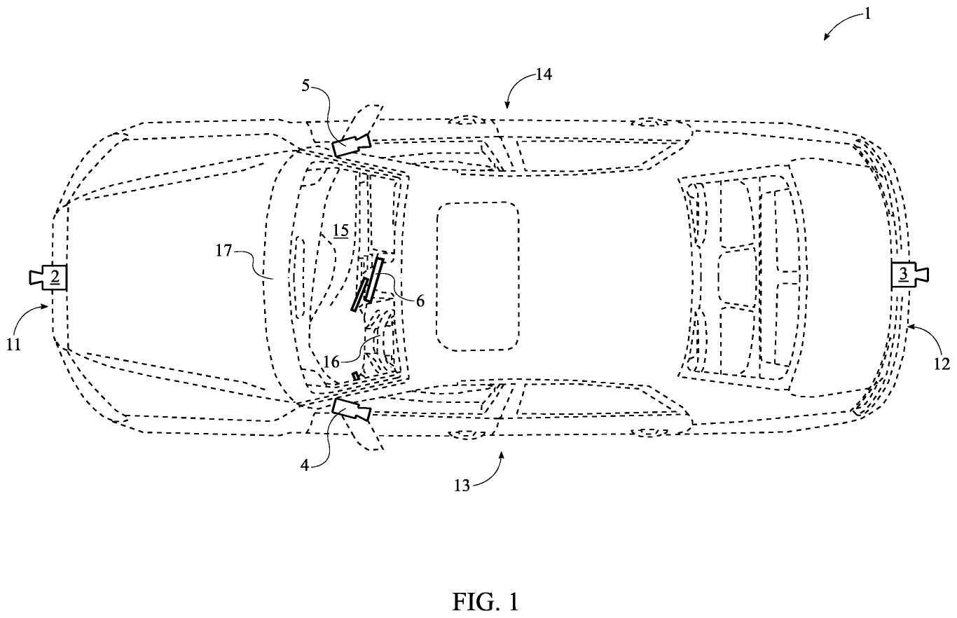

As can be seen invention FIG. 1, the present invention is a vehicular camera system that is used to improving the driver's visibility around the entire perimeter of the vehicle 1. Thus, the present invention comprises a vehicle 1, at least one front camera 2, at least one rear camera 3, at least one left camera 4, at least one right camera 5, and at least one display panel 6. The front camera 2 is used to capture a more comprehensive view from a front end 11 of the vehicle 1. The rear camera 3 is used to capture a more comprehensive view from a rear end 12 of the vehicle 1. The left camera 4 is used to capture a more comprehensive view from a left side 13 of the vehicle 1. The right camera 5 is used to capture a more comprehensive view from a right side 14 of the vehicle 1. These cameras allow the present invention to capture footage of the area surrounding the vehicle 1, and this footage is then visually outputted to the driver through the display panel 6 in real-time.

The general configuration of the aforementioned components allows the present invention to effectively and efficiently provide the driver with a visual awareness of the area surrounding the vehicle 1. The front camera 2 is mounted onto the front end 11 and is oriented away from the front end 11, which allows the front camera 2 to capture footage viewing outward from the front end 11. Similarly, the rear camera 3 is mounted onto the rear end 12 and is oriented away from the rear end 12, which allows the rear camera 3 to capture footage viewing outward from the rear end 12. The rear camera 3 can be used either to supplement or to completely replace the rear-view mirror that is typical found in a vehicle. The left camera 4 is mounted onto the left side 13 and is oriented towards the rear end 12 while being angular offset from the left side 13 so that the left camera 4 is able to capture footage of a typical blind spot near the left quarter panel of the vehicle 1. Likewise, the right camera 5 is mounted onto the right side 14 and is oriented towards the rear end 12 while being angular offset from the right side 14 so that the right camera 5 is able to capture footage of a typical blind spot near the right quarter panel of the vehicle 1. Moreover, the display panel 6 is mounted onto a dashboard 15 of the vehicle 1 and is peripherally positioned to the steering wheel 16, which allows the driver to readily view the display panel 6. The manner in which the display panel 6 is mounted onto the dashboard 15 includes, but is not limited to, mounts, docks, or removable fasteners. The front camera 2, the rear camera 3, the left camera 4, and the right camera 5 are communicably coupled to the display panel 6 in order to transfer the footage captured by the aforementioned cameras to the display panel 6. The aforementioned cameras and the display panel 6 can be communicably coupled either through a wired means, such as cables, or through a wireless means, such as short-range radio frequency (RF) devices (e.g. Bluetooth).

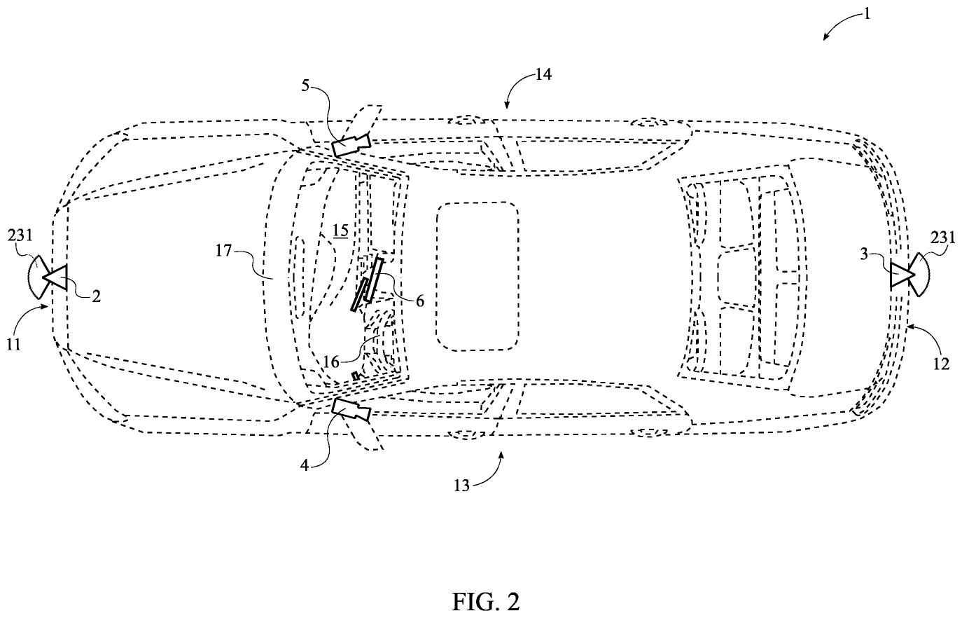

The front camera 2 and the rear camera 3 can be configured, but is not limited to, two different embodiments. In one embodiment illustrated in FIG. 2, the at least one front camera 2 and/or the at least one rear camera 3 each are a single camera. Consequently, a wide-angle lens 231 needs to be operatively integrated into the single camera. This allows the wide-angle lens 231 of the single camera to capture a panoramic front view with the front camera 2. This also allows the wide-angle lens 231 of the single camera to capture a panoramic rear view with the rear camera 3.

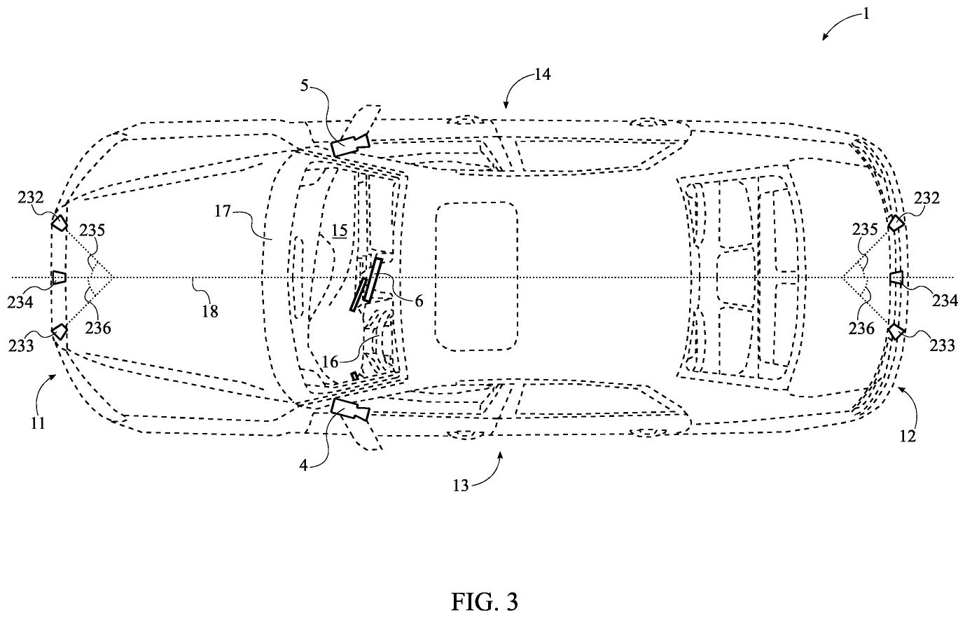

In another embodiment illustrated in FIG. 3, the at least one front camera 2 and/or the at least one rear camera 3 each comprise a first lateral camera 232, a second lateral camera 233, and a central camera 234. The central camera 234 is used to capture footage that is a straight-ahead view of either the front end 11 or the rear end 12, which is done by orienting the central camera 234 parallel to a roll axis 18 of the vehicle 1. The roll axis 18 extends through the front end 11, the center of gravity for the vehicle 1, and the rear end 12 and is defined as the rotation axis about which the vehicle 1 rolls over. The first lateral camera 232 is positioned adjacent to the central camera 234, and the second lateral camera 233 is positioned adjacent to the central camera 234, opposite to the first lateral camera 232, so that the first lateral camera 232 and the second lateral camera 233 can be used to capture footage of peripheral views of either the front end 11 or the rear end 12. The first lateral camera 232 is oriented at a first angle 235 with the roll axis 18 of the vehicle 1 so that the first lateral camera 232 is able to capture one side of the peripheral view. Similarly, the second lateral camera 233 is oriented at a second angle 236 with the roll axis 18 of the vehicle 1 so that the second lateral camera 233 is able to capture the other side of the peripheral view. The first angle 235 and the second angle 236 preferably mirror each other and are either acute angles or right angles. However, if the first angle 235 and the second angle 236 are obtuse angles, then the first lateral camera 232 and the second lateral camera 233 would be inoperably oriented towards the front end 11 or the rear end 12, instead of being oriented away from the front end 11 or the rear end 12. In addition, an orientation for the central camera 234, an orientation of the first lateral camera 232, and an orientation of the second lateral camera 233 respectively bisect a viewing range of the central camera 234, a viewing range of the first lateral camera 232, and a viewing range of the second lateral camera 233. The viewing range of the central camera 234, the first lateral camera 232, and the second camera is preferably 170 degrees.

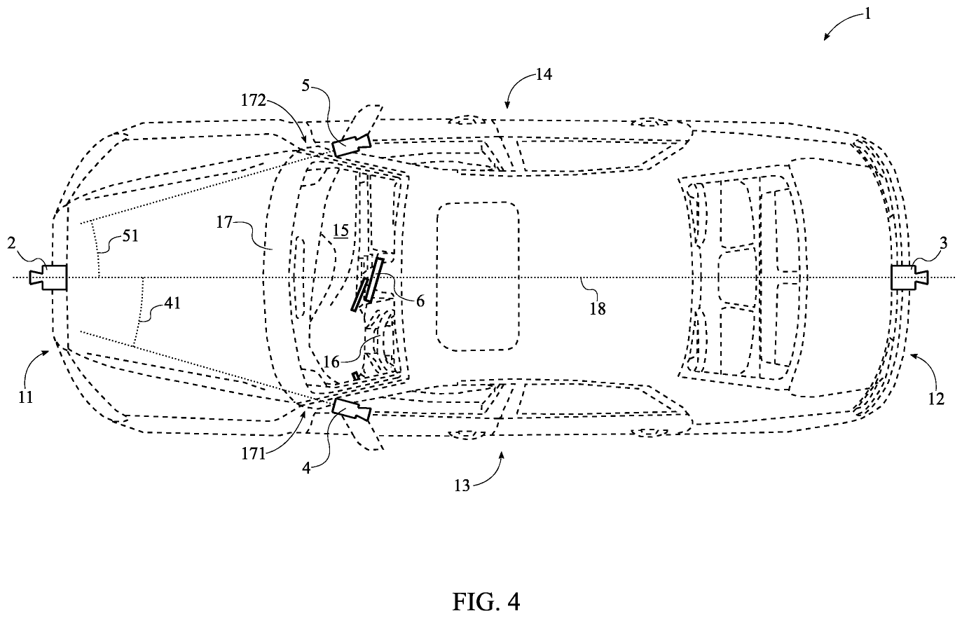

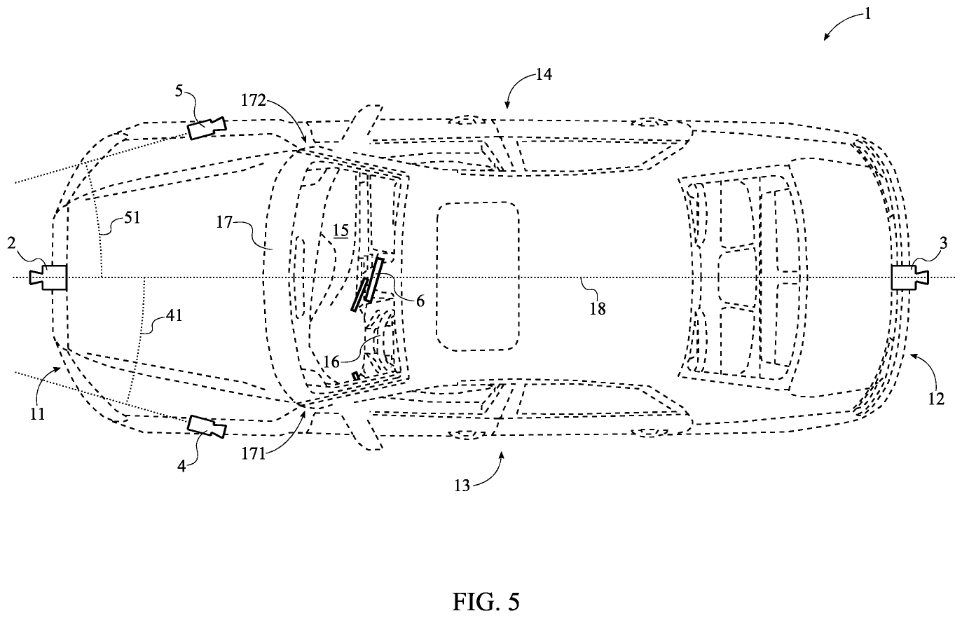

The left camera 4 is orientated at a third angle 41 with the roll axis 18 of the vehicle 1 so that the present invention eliminates the prevalent blind spot near the left quarter panel of the vehicle 1. The left camera 4 is not used to capture footage that is a straight-ahead view of the left side 13 because this visual aid would not be helpful for the driver of the vehicle 1 during normal driving situations. The left camera 4 can be configured, but is not limited to, two different embodiments, both of which are defined in relation to a forward windshield 17 of the vehicle 1. In one embodiment illustrated in FIG. 4, the left camera 4 is positioned adjacent to the lower left corner 171 of the forward windshield 17, which allows the left camera 4 to focus on the blind spot near the left quarter panel. In another embodiment illustrated in FIG. 5, the left camera 4 is positioned in between the front end 11 and the forward windshield 17, which does not allow the left camera 4 to focus on the blind spot near the left quarter panel. However, this embodiment allows the left camera 4 to capture a wider view of the area near the left quarter panel. In both embodiments, the third angle 41 is preferably an acute angle. Also in both embodiments, the left camera 4 can be used either to supplement or to completely replace the left-side mirror of a vehicle 1. In some other embodiments, the at least one left camera 4 can be a pair of cameras, wherein one left camera is positioned adjacent to the lower left corner 171 of the forward windshield 17, and wherein the other left camera is positioned in between the front end 11 and the forward windshield 17.

Likewise, the right camera 5 is orientated at a fourth angle 51 with the roll axis 18 of the vehicle 1 so that the present invention eliminates the prevalent blind spot near the right quarter panel of the vehicle 1. The right camera 5 is not used to capture footage that is a straight-ahead view of the right side 14 because this visual aid would not be helpful for the driver of the vehicle 1 during normal driving situations. Similar to the left camera 4, the right camera 5 can be configured, but is not limited to, two different embodiments, both of which are defined in relation to the forward windshield 17 of the vehicle 1. In one embodiment illustrated in FIG. 4, the right camera 5 is positioned adjacent to the lower right corner 172 of the forward windshield 17, which allows the right camera 5 to focus on the blind spot near the right quarter panel. In another embodiment illustrated in FIG. 5, the right camera 5 is positioned in between the front end 11 and the forward windshield 17, which does not allow the right camera 5 to focus on the blind spot near the right quarter panel. However, this embodiment allows the right camera 5 to capture a wider view of the area near the right quarter panel. In both embodiments, the fourth angle 51 is preferably an acute angle. Also in embodiments, the right camera 5 can be used either to supplement or to completely replace the right-side mirror of a vehicle 1. In some other embodiments, the at least one right camera 5 can be a pair of cameras, wherein one right camera is positioned adjacent to the lower right corner 172 of the forward windshield 17, and wherein the other right camera is positioned in between the front end 11 and the forward windshield 17.

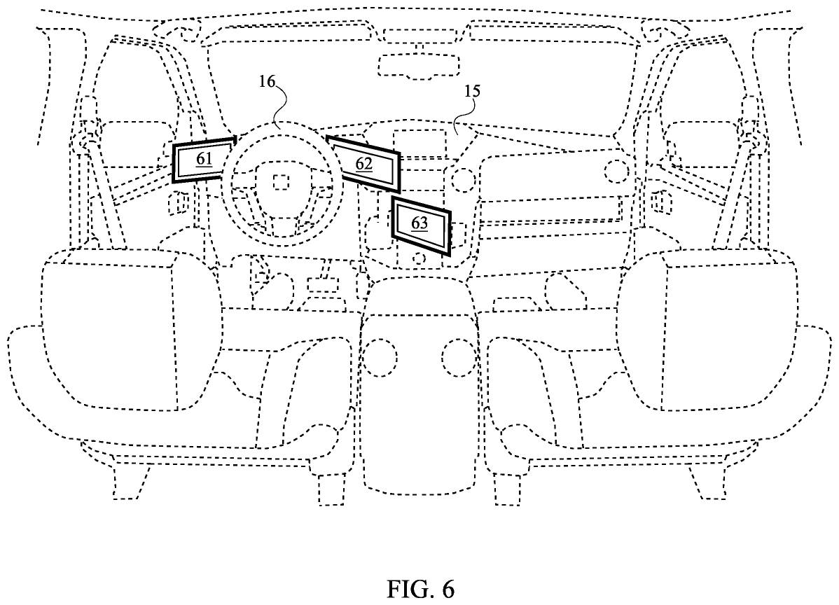

Multiple display panels are necessary to visually organize the footage from the different aforementioned cameras. Thus, the at least one display panel 6 needs to comprise a left display panel 61, the right display panel 62, and the front/rear display panel 63, which are shown in FIG. 6. The left display panel 61 is used to visually output the footage captured by the left camera 4, and the right display panel 62 is used to visually output the footage of the captured by the right camera 5. The front/rear display panel 63 is used to visually output the footage captured by the front camera 2 if the vehicle 1 is moving in a forward direction and is used to visually output the footage captured by the rear camera 3 if the vehicle 1 is moving in a reverse direction. In order to provide the driver with an easily discernable setup around steering wheel 16, the left display panel 61 and the right display panel 62 are positioned opposite to each other about the steering wheel 16, which allows the left display panel 61 to be positioned proximal to the left camera 4 and allows the right display panel 62 to be positioned proximal to the right camera 5. The front/rear display panel 63 is positioned adjacent to the right display panel 62 so that the aforementioned display panels do not interfere with the general movement of the driver's limbs while operating the vehicle 1.

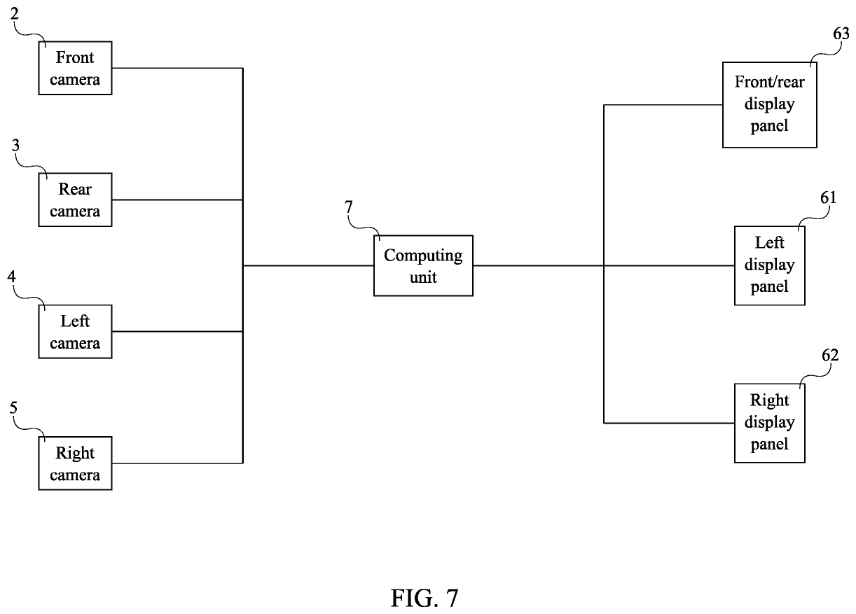

As can be seen in FIG. 7, the present invention may further comprise a computing unit 7 in order to process and/or annotate the footage captured by the front camera 2, the rear camera 3, the left camera 4, and the right camera 5. Thus, the front camera 2, the rear camera 3, the left camera 4, and the right camera 5 are communicably coupled to the display panel 6 through the computing unit 7. For example, when the vehicle 1 is moving in the reverse direction, the computing unit 7 can visually integrate directional parking-assistance lines as the display panel 6 outputs the footage captured by the reverse camera.

The aforementioned cameras may be configured with certain ancillary features that improve the overall effectiveness and efficiency of the present invention. One ancillary feature is that the front camera 2, the rear camera 3, the left camera 4, and the right camera 5 are each configured to capture night-vision footage because a vehicle 1 is just as likely to be driven in the nighttime as in the daytime. Another ancillary feature is that the front camera 2, the rear camera 3, the left camera 4, and the right camera 5 are each configured with a rain cover in order to prevent precipitation from obstructing the footage captured by the aforementioned cameras. Another ancillary feature is that the front camera 2, the rear camera 3, the left camera 4, and the right camera 5 are each configured to rotate in order to capture footage from a wider range. The rotatable feature would be most useful for the first lateral camera 232 and the second lateral camera 233 of either the at least one front camera 2 and/or the at least one rear camera 3 and for the left camera 4 and the right camera 5.

It should be understood that the present invention comprises the necessary fastening means such that each of the aforementioned cameras is properly secured into the exterior surfaces of the vehicle 1. It should also be understood that each of the aforementioned cameras and the display panel 6 are connected to a power source, which is typically the battery of the vehicle 1. It should also be understood that the aforementioned cameras and the display panel are able to synchronously draw power from the battery of vehicle. More specifically, the present invention automatically turns on if the driver turns on the vehicle 1 and turns off if the driver turns off the vehicle 1. The present invention may also comprise a plurality of manual controls that control display properties of the display panel 6 and control the movement to reorient the left camera 4 or the right camera 5. An alternate embodiment of the present invention may comprise a sensing mechanism that alerts the driver of potential danger and operatively synchronizes with the aforementioned cameras.

In order to properly use the present invention, the driver simply turns on the vehicle 1 and drives as he or she normally does. However, the driver does not need to turn his or her head in any direction other than forward. The driver may view the front/rear display panel 63 as he or she is parking, positioning the vehicle 1, or backing up the vehicle 1 into position. The driver may view the left display panel 61 or the right display panel 62 as he or she is turning forward or turning backward. The driver does not have any more blind spots as the aforementioned cameras present all the surrounding environment from all angles.

Although the invention has been explained in relation to its preferred embodiment, it is to be understood that many other possible modifications and variations can be made without departing from the spirit and scope of the invention as hereinafter claimed.

What is claimed is:

1. A vehicular camera system for improving a driver's visibility comprises:
a vehicle;
at least one front camera;
at least one rear camera;
at least one left camera;
at least one right camera;
at least one display panel;
the vehicle comprises a front end, a rear end, a left side, a right side, a dashboard, and a steering wheel;
the front camera being mounted onto the front end;
the front camera being oriented away from the front end;
the rear camera being mounted onto the rear end;
the rear camera being oriented away from the rear end;
the left camera being mounted onto the left side;
the left camera being oriented towards the rear end, angularly offset from the left side;
the right camera being mounted onto the right side;
the right camera being oriented towards the rear end, angularly offset from the right side;
the display panel being mounted onto the dashboard;
the display panel being peripherally positioned to the steering wheel; and
the front camera, the rear camera, the left camera, and the right camera being communicably coupled with the display panel.

2. The vehicular camera system for improving a driver's visibility as claimed in claim 1 comprises:
the at least one front camera being a single camera; and
a wide-angle lens being operatively integrated into the single camera, wherein the wide-angle lens is used to capture a panoramic view with the single camera.

3. The vehicular camera system for improving a driver's visibility as claimed in claim 1 comprises:
the at least one front camera comprises a first lateral camera, a second lateral camera, and a central camera;
the first lateral camera being positioned adjacent to the central camera;
the second lateral camera being positioned opposite to the central camera, opposite to the first lateral camera;
the central camera being oriented parallel to a roll axis of a vehicle;
the first lateral camera being oriented at a first angle with the roll axis of the vehicle; and
the second lateral camera being oriented at a second angle with the roll axis of the vehicle.

4. The vehicular camera system for improving a driver's visibility as claimed in claim 3, wherein the first angle and the second angle are acute angles and mirror each other.

5. The vehicular camera system for improving a driver's visibility as claimed in claim 3, wherein the first angle and the second angle are right angles and mirror each other.

6. The vehicular camera system for improving a driver's visibility as claimed in claim 3, wherein the first lateral camera, the second lateral camera, and the central camera are each configured with a viewing range of 170 degrees.

7. The vehicular camera system for improving a driver's visibility as claimed in claim 1 comprises:
the at least one rear camera being a single camera; and
a wide-angle lens being operatively integrated into the single camera, wherein the wide-angle lens is used to capture a panoramic view with the single camera.

8. The vehicular camera system for improving a driver's visibility as claimed in claim 1 comprises:
the at least one rear camera comprises a first lateral camera, a second lateral camera, and a central camera;
the first lateral camera being positioned adjacent to the central camera;
the second lateral camera being positioned opposite to the central camera, opposite to the first lateral camera;
the central camera being oriented parallel to a roll axis of a vehicle;
the first lateral camera being oriented at a first angle with the roll axis of the vehicle; and
the second lateral camera being oriented at a second angle with the roll axis of the vehicle.

9. The vehicular camera system for improving a driver's visibility as claimed in claim 8, wherein the first angle and the second angle are acute angles and mirror each other.

10. The vehicular camera system for improving a driver's visibility as claimed in claim 8, wherein the first angle and the second angle are right angles and mirror each other.

11. The vehicular camera system for improving a driver's visibility as claimed in claim 8, wherein the first lateral camera, the second lateral camera, and the central camera are each configured with a viewing range of 170 degrees.

12. The vehicular camera system for improving a driver's visibility as claimed in claim 1 comprises:
the left camera being oriented at a third angle with a roll axis of the vehicle.

13. The vehicular camera system for improving a driver's visibility as claimed in claim 12 comprises:
the vehicle further comprises a forward windshield; and
the left camera being positioned adjacent to a lower left corner of the forward windshield.

14. The vehicular camera system for improving a driver's visibility as claimed in claim 12 comprises:
the vehicle further comprises a forward windshield; and
the left camera being positioned in between the front end and the forward windshield.

15. The vehicular camera system for improving a driver's visibility as claimed in claim 12, wherein the third angle is an acute angle.

16. The vehicular camera system for improving a driver's visibility as claimed in claim 1 comprises:
the right camera being oriented at a fourth angle, offset from the roll axis of the vehicle.

17. The vehicular camera system for improving a driver's visibility as claimed in claim 16 comprises:
the vehicle further comprises a forward windshield; and
the right camera being positioned adjacent to a lower right corner of the forward windshield.

18. The vehicular camera system for improving a driver's visibility as claimed in claim 16 comprises:
the vehicle further comprises a forward windshield; and
the right camera being positioned in between the front end and the forward windshield.

19. The vehicular camera system for improving a driver's visibility as claimed in claim 16, wherein the fourth angle is an acute angle.

20. The vehicular camera system for improving a driver's visibility as claimed in claim 1 comprises:
the at least one display panel comprises a left display panel, a right display panel, and a front/rear display panel;
the left display panel and the right display panel being positioned opposite to each other about the steering wheel;
the left display panel being positioned proximal to the left camera;
the right display panel being positioned proximal to the right camera; and
the front/rear display panel being positioned adjacent to the right display panel.

21. The vehicular camera system for improving a driver's visibility as claimed in claim 1 comprises:
a computing unit; and
the front camera, the rear camera, the left camera, and the right camera being communicably coupled with the display panel through the computing unit.

22. The vehicular camera system for improving a driver's visibility as claimed in claim 1, wherein the front camera, the rear camera, the left camera, and the right camera are each configured to capture night-vision footage.

23. The vehicular camera system for improving a driver's visibility as claimed in claim 1, wherein the front camera, the rear camera, the left camera, and the right camera are each configured with a rain cover.
